(19) United States
(12) Patent Application Publication
(10) Pub. No.: US 2016/0087731 A1
(43) Pub. Date: Mar. 24, 2016

(54) SYSTEM AND METHODS FOR INTERFERENCE AVOIDANSE FOR LONG RANGE WIRELESS MARINE COMMUNICATION

(71) Applicant: TRUEPATH TECHNOLOGIES, LLC, RICHMOND, VA (US)

(72) Inventor: Michael A. Leabman, San Ramon, CA (US)

(21) Appl. No.: 14/833,086

(22) Filed: Aug. 22, 2015

Related U.S. Application Data
(63) Continuation-in-part of application No. 12/830,324, filed on Jul. 4, 2010, now Pat. No. 8,467,733.
(60) Provisional application No. 62/041,022, filed on Aug. 22, 2014.
(60) Provisional application No. 61/213,999, filed on Aug. 6, 2009.
(60) Provisional application No. 61/272,001, filed on Aug. 6, 2009.

(51) Int. Cl. H04B 15/00; H04B 7/04; H04B 7/10

(52) U.S. Cl. CPC H04B 15/00; H04B 7/10; H04B 7/0408

(57) ABSTRACT

The present invention generally relates to systems and methods for improving the quality of communication between a ground station and the ship by avoiding destructive interference between direct and reflected signal paths and thus offering enhancement in the quality of long range marine wireless communication.

### CROSS REFERENCE TO RELATED APPLICATIONS

This application claims priority and is a continuation-in-part of U.S. provisional application No. 62/041,022, filed Aug. 22, 2014, entitled the same.

This continuation-in-part application also claims priority to U.S. application Ser. No. 12/830,324, filed Jul. 4, 2010, entitled “System and Methods for Wireless Broadband Delivery of Data”, now U.S. Pat. No. 8,467,733, and further which claims priority from provisional applications No. 61/213,999 filed Aug. 6, 2009, entitled “Broadband Wireless Communication”, and provisional application No. 61/272,001 filed Aug. 6, 2009, entitled “MAC and Antenna Optimizations for Long-Distance Wireless Communication”.

This application also is related to U.S. application Ser. No. 12/830,326, filed Jul. 4, 2010, entitled “System and Methods for Simultaneous Wireless Broadband Communication Between Multiple Base Stations”, now abandoned.

Further, this application is related to U.S. application Ser. No. 12/830,327, filed Jul. 4, 2010, entitled “System and Methods for Antenna Optimization for Wireless Broadband Communication”, now U.S. Pat. No. 8,614,643.

Additionally, this application is related to U.S. application Ser. No. 12/830,328, filed Jul. 4, 2010, entitled “System and Methods for Scalable Processing of Received Radio Frequency Beamform Signal”, now U.S. Pat. No. 8,923,189.

Lastly, this application is related to U.S. application Ser. No. 12/830,329, filed Jul. 4, 2010, entitled “System and Methods for Media Access Control Optimization for Long Range Wireless Communication”, now U.S. Pat. No. 8,880,059.

All the above-listed applications and patents are incorporated in their entirety by reference herein for all purposes.

### BACKGROUND OF THE INVENTION

The present invention relates to marine communication systems and methods. More particularly, the present invention relates to systems and methods for interference avoidance for the enablement of delivering data over long range wireless communication systems, such as communications between marine vessels and land-based stations. In some embodiments, this data delivery system may provide data at high throughput data rates exceeding 100 Mbps to enable the transfer of a wide variety of safety, operational and passenger data.

Communication and information access is imperative to the marine industry. Earliest commercial marine vessels had primitive voice communication with land personnel over two way shortwave radio. This communication means improved sailing safety.

Since then, marine vessels connectivity to land have been further upgraded with advent of radar, computers, and even data links to further improve communications. These technologies serve to improve further sailing safety and provide amenities to passengers of cruise ships. Other approaches to providing data connectivity to commercial cruise ships are to install Satellite Ku Band or Cellular receivers. However, true broadband high-throughput data uplinks are typically lacking for the marine industry. This is due difficulty in sending communication signals over a long range in a sea or an ocean. This difficulty stems from interference between direct and reflected signal paths. This made it difficult to supply high bit rate data connectivity to an entire fleet of commercial cruise ships, for example.

Ships sailing at sea face unique challenges. They require the same connectivity found at the corporate office but for their remote sites often located thousands of miles offshore. To focus on their core missions such as commercial cruise ship operations, seismic and tsunami observation, and transoceanic shipping, these ships need a comprehensive communications that can provide end-to-end solutions so that they can focus on the mission at hand.

For example commercial cruise ships face communication demands ranging from providing passenger entertainment services to delivering corporate data and information to captains and crews so they can manage their vessels efficiently. Leveraging highly reliable communications is critical to ensure that vessels experience no operational downtime and can be operated with the full amenities and functionality available as if the cruise ships were actually resorts onshore.

Operational and maintenance needs are driven by cost savings the commercial cruise ship may recapture by knowing, real-time, the condition of the commercial cruise ship. Gigabytes of sailing data are accumulated for each trip but are not easily accessible until after the commercial cruise ship has reached the end port (or are even totally inaccessible if not stored for later retrieval). This renders real time engine trends, fuel consumption rates, and parts performance variances unavailable for timely repairs and cost savings. Generally, important operational data is collected and downloaded via a wired access port when the commercial cruise ship has docked. This data collection, however, is not real time data, and cannot be utilized to preplan maintenance needs.

Safety needs include the ability to identify causes and possibly prevent disastrous accidents by providing real-time data from ground stations about for example pending storms. Also, in case of accidents, the causal data is very important in generating protocols and/or safety inspections to prevent future similar accidents. Likewise, if critical commercial cruise ship conditions were known by ground personnel in real time, potential disasters could possibly be identified and addressed before they happen. These safety needs are currently unmet given current limited data bandwidth and signal fidelity to commercial cruise ships.

In view of the foregoing, systems and methods for sending communication signals over a long range in a sea or an ocean that avoids interference between direct and reflected signal paths and thus offer optimization for long distance wireless communication are disclosed.

### SUMMARY

During a long range wireless communication between a ground station and a ship in a sea or an ocean destructive interference can take place between two portions of a transmitted electromagnetic formed beam. Wherein, one portion of the formed beam took a direct path to the ship and the other portion of the formed beam reflected off the sea surface.

This destructive interference can result in fading of signals received at the ship with accompanying significant degrade in the quality of communication between the ground station and the ship.

One embodiment according to the present invention mitigates the above described adverse effect by transmitting a formed beam incorporating two types of circular polarization having same carrier frequency. Resulting in reduction in destructive interference between the portion of the formed beam taking the direct path to the ship and the portion of the formed beam reflected off the sea surface and thus resulting in less fading of the communication signal as received at a receiving antenna onboard the ship.

In another embodiment according to the present invention, the formed beam is being transmitted from two sets of antennae. One set of antennae transmits a combination of right-handed-circularly polarized electromagnetic waves and left-handed-circularly polarized electromagnetic waves, both polarizations are at a certain carrier frequency. The other set of antennae transmits a combination of right-handed-circularly polarized electromagnetic waves and left-handed-circularly polarized electromagnetic waves, both at a carrier frequency different from the one transmitted by first set of antennae. This results in further significant reduction in fading of the communication signal as received at a receiving antenna onboard the ship and substantial improvement in the quality of communication between the ground station and the ship.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example illustration of a formed beam emitted from a ground station to a ship in the sea with the accompanying reflection off the sea surface;

FIG. 2 is an example illustration of a ground station emitting a formed beam using two different modes of circularly polarized electromagnetic wave; and

FIG. 3 is an illustration of a ground station emitting a formed beam using two different modes of circularly polarized electromagnetic waves and two different carrier frequencies.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “only,” “must,” “must not,” “first,” “initially,” “next,” “subsequently,” “before,” “after,” “lastly,” and “finally,” are not meant to limit the scope of the present invention as the embodiments disclosed herein are merely exemplary.

In addition, as used in this specification and the appended claims, the singular article forms “a,” “an,” and “the” include both singular and plural referents unless the context of their usage clearly dictates otherwise. Thus, for example, reference to “a piston” includes a plurality of springs as well as a single piston, reference to “an outlet” includes a single outlet as well as a collection of outlets, and the like.

Some of the electromagnetic waves emitted by ground stations as a formed beam toward a ship in the sea suffer from being reflected when reaching the sea surface. This reflection results in interference between a portion of the formed beam that took a direct path to the ship and a portion of the formed beam reflected off the sea surface. This interference can cause fading of the signal received at ship antenna affecting the quality of communication between the ground stations and the ship.

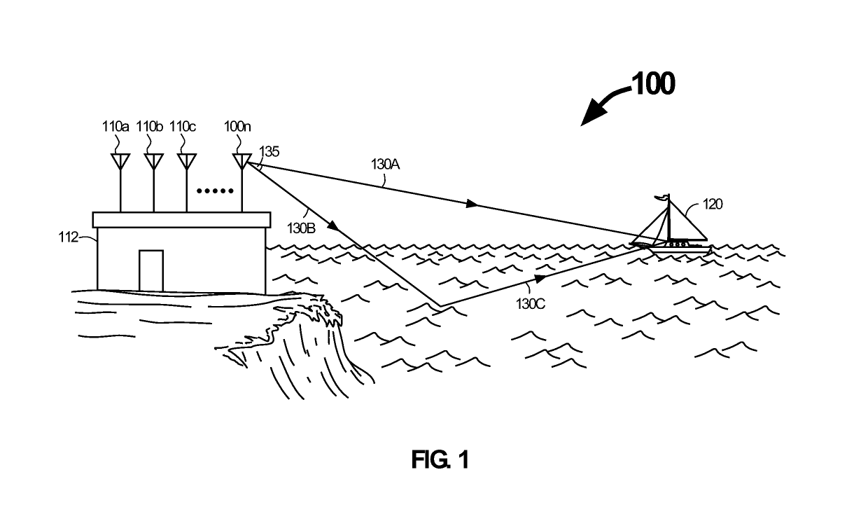

In FIG. 1 we consider the communication system 100. A phased array antenna of elements 110a, 110b, 110c, . . . , 110n is located in a ground station 112 and emits a formed beam directed towards a ship 120 sailing in a sea (or an ocean) away from the shore. An electromagnetic ray 130A follows a direct path from the ground station 112 to the ship 120. An electromagnetic ray 130B hits the sea surface and gets reflected into an electromagnetic ray 130C. Both the electromagnetic ray 130A and the electromagnetic ray 130B are part of the formed beam emitted from the ground station 112 towards the ship 120. In most cases the distance between the ground station 112 and the ship 120 is much larger than the height of the ground station 112 such that an angle 135 between the two electromagnetic ray 130A and 130B is small. In most practical cases the angle 135 may be approximately of the order of a few minutes.

The two electromagnetic rays 130A and 130C received at the ship 120 interfere at ships receiving antenna. This interference can be constructive interference or destructive interference depending on the position of the ship 120 and its distance from the ground station 112. The interference between the two electromagnetic rays 130A and 130C also depends on the frequency of the formed beam emitted from the ground station 112.

Depending on the frequency of the formed beam emitted from the ground station 112, the destructive interference between of the two electromagnetic rays 130A and 130C would be worst at certain repeated positions of the ship 120. These repeated positions can correspond to almost total cancelations of the two electromagnetic rays 130A and 130C. This occurs when the phase difference between the two electromagnetic rays 130A and 130C, as they are received at the antenna onboard the ship 120, is approximately 180 degrees. This condition would result in an approximate null signal received at the ship 120 receiving antenna. This condition drastically degrades the quality of communication between the ground station 112 and the ship 120.

Let us consider an example where a ship is 100's of miles away from the ground station. The angle 135 may be approximately of the order of a few minutes. If we consider the case of the angle 135 is 2 minutes and that the carrier frequency is 3 GHz, then we can estimate the positions where the conditions would result in the approximate null signal received at the ship 120 receiving antenna. The condition where the phase difference between the two electromagnetic rays 130A and 130C would be 180 degrees would occur whenever the following condition applies:

(130B+130C)−130A=mλ/2

where m=1, 3, 5, . . . an odd number λ is the wavelength corresponding to the carrier frequency which is 3 GHz

In our example above, calculations for the angle 135 is 2 minutes results in the fading of signals at approximate ship positions of: 184 miles, 551 miles, 918 miles, 1285 miles, . . . . A second case for the angle 135 is 3 minutes results in the fading of signals at approximate ship positions of: 82 miles, 245 miles, 408 miles, 571 miles, . . . . A third case for the angle 135 is 4 minutes results in the fading of signals at approximate ship positions of: 46 miles, 138 miles, 229 miles, 321 miles, . . . .

One embodiment of the present invention offers a solution to the above described fading of the communication signal received at the antenna onboard the ship 120. According to this embodiment, a plurality of antennae is used to emit a formed beam. Some of the plurality of antennae emits electromagnetic waves that are circularly polarized in the right-handed-circular circular (RHC) polarization mode. The rest of the plurality of antennae emits electromagnetic waves that are circularly polarized in the left-handed-circular (LHC) polarization mode.

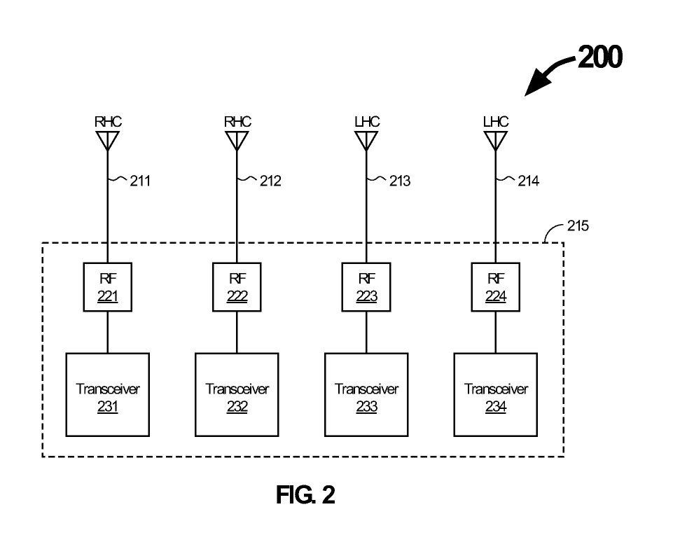

FIG. 2 depicts an example of the above embodiment. A configuration 200 includes a ground station 215 which emits a formed beam towards a ship (not shown) in a sea or an ocean. The formed beam is emitted using four antennae 211, 212, 213, and 214. The two antennae 211 and 212 emit electromagnetic waves that are circularly polarized in the right-handed-circular (RHC) polarization mode. The two antennae 213 and 214 emit electromagnetic waves that are circularly polarized in the left-handed-circular (LHC) polarization mode. All of the antennae 211, 212, 213, and 214 emit electromagnetic waves having the same carrier radio frequency (RF).

The four antennae 211, 212, 213, and 214 are fed by four RF circuits 221, 222, 223, and 224 respectively as depicted in FIG. 2. The four RF circuits 221, 222, 223, and 224 are operatively coupled to four transceivers 231, 232, 233, and 234 respectively. Each of the four transceivers 231, 232, 233, and 234 incorporates a local oscillator (not shown) to generate the carrier RF frequency.

The four RF circuits 221, 222, 223, and 224 are connected to a Global Positioning System (GPS) system (not shown) that determines relative position of ship with respect to the ground station 215. The information gained from the GPS system is used to control the amplitudes and phases of the RF fed to the four antennae 211, 212, 213, and 214 to direct the formed beam towards the ship.

The above embodiment of the communication configuration reduces the impact of the interference between the portion of the formed beam that took a direct path to ship and the portion of the formed beam reflected off the sea surface. Resulting in less fading of the communication signal as received at the ship 120 receiving antenna.

In another embodiment of the present invention, two sets of antennae are used. One set of the antennae transmits a combination of right-handed-circularly polarized electromagnetic waves and left-handed-circularly polarized electromagnetic waves both at a certain radio frequency (RF). The other set of the antennae transmits a combination of right-handed-circular electromagnetic waves and left-handed-circularly polarized electromagnetic waves both at a different RF frequency. The use of two different frequencies further improves the signal fade reduction by minimizing interference.

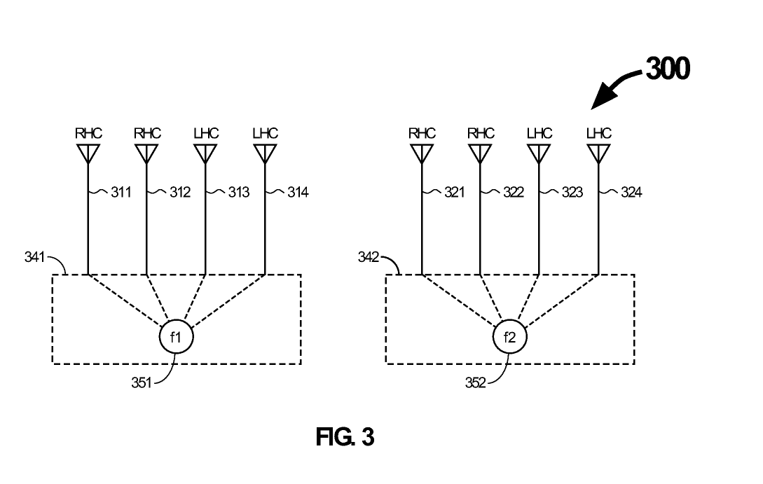

FIG. 3 depicts an example of the above embodiment. A configuration 300 is shown, where the ground station uses two sets of antennae to emit a formed beam towards a ship (not shown) in a sea or an ocean. The first set is comprised of four antennae 311, 312, 313, and 314. The second set is comprised of four antennae 321, 322, 323, and 324. The four antennae 311, 312, 313, and 314 are fed by an RF circuitry 341 which incorporates a local oscillator 351 generating a carrier frequency G. The four antennae 321, 322, 323, and 324 are fed by an RF circuitry 342 which incorporates a local oscillator 352 generating a carrier frequency f₂.

The first set encompassing the four antennae 311, 312, 313, and 314 has the two antennae 311 and 312 emitting of right-handed-circularly (RHC) polarized electromagnetic waves and the two antennae 313 and 314 emitting of left-handed-circular (LHC) electromagnetic waves. Similarly, the second set encompassing the four antennae 321, 322, 323, and 324 has the two antennae 321 and 322 emitting of right-handed-circularly (RHC) polarized electromagnetic waves and the two antennae 323 and 324 emitting of left-handed-circular (LHC) polarized electromagnetic waves.

It is to be noted that in one favorable embodiment, the difference in frequency between the carrier frequencies G and f₂ can be approximately about one to two percentage of the carrier f₁. For example, the carrier frequency f₁ can be 5.76 GHz and the carrier frequency f₂ can be 5.766 GHz. Thus in this example, the difference in frequency is 60 MHz which is a little more than 1% of the carrier frequency f₁ (5.76 GHz).

In another favorable embodiment of this invention, the carrier frequency f₂ can be much different from the carrier frequency f₁. For example, the carrier frequency f₁ can be in the C-band frequency range such as 5.76 GHz while the carrier frequency f₂ can be in the S-band frequency range such as 2.46 GHz.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for interference avoidance during a long range wireless communication between a ground station and a ship in a sea, the method comprising:
transmitting a formed beam of electromagnetic waves form a plurality of antennae in the ground station, wherein plurality of antennae is grouped into two sets of antennae;
polarizing a part of the formed beam of electromagnetic waves emitted from a first set of antennae in the ground station in a right-handed-circular (RHC) polarization mode;
polarizing a part of the formed beam of electromagnetic waves emitted from a second set of antennae in the ground station in a left-handed-circular (LHC) polarization mode;
feeding radio frequency (RF) signals to each antenna of the two sets of antennae; and
using a Global Positioning System (GPS) system to determine relative position of the ship with respect to the ground station.

2. The method in claim 1, wherein polarizing of parts of the formed beam in the right-handed-circular (RHC) polarization mode and in the left-handed-circular (LHC) polarization mode substantially reduces destructive interference between a portion of the formed beam taking a direct path to the ship and a portion of the formed beam reflected off the sea surface.

3. The method in claim 1, wherein the reduction in destructive interference between the portion of the formed beam taking the direct path to the ship and the portion of the formed beam reflected off the sea surface results in less fading of the communication signal as received at a receiving antenna onboard the ship.

4. The method in claim 1, wherein the radio frequency signals fed to each antenna are generated from a separate RF circuit and a separate transreceiver.

5. The method in claim 1, wherein the radio frequency signals fed to each antenna are all having the same carrier frequency.

6. A method for improving interference avoidance during long range wireless communication between a ground station and a ship in a sea, the method comprising:
transmitting a formed beam of electromagnetic waves form a plurality of antennae in the ground station grouped into two sets of antennae;
transmitting a first part of the formed beam from a first set of the two sets of antennae, wherein the first part of the formed beam is comprised of a combination of right-handed-circularly polarized electromagnetic waves and left-handed-circularly polarized electromagnetic waves, both at a first carrier frequency;
transmitting a second part of the formed beam from a second set of the two sets of antennae, wherein the second part of the formed beam is comprised of a combination of right-handed-circularly polarized electromagnetic waves and left-handed-circularly polarized electromagnetic waves, both at a second carrier frequency;
feeding radio frequency (RF) signals to each antenna of the two sets of antennae; and
using a Global Positioning System (GPS) system to determine relative position of the ship with respect to the ground station.

7. The method in claim 6, wherein transmitting the formed beam emitted from the said two sets substantially reduces destructive interference between a portion of the formed beam taking a direct path to the ship and a portion of the formed beam reflected off the sea surface.

8. The method in claim 6, wherein the reduction in destructive interference between the portion of the formed beam taking the direct path to the ship and the portion of the formed beam reflected off the sea surface results in significant reduction in fading of the communication signal as received at a receiving antenna onboard the ship.

9. The method in claim 6, wherein the first carrier frequency and the second carrier frequency are of different values within approximately one to two percent of the first carrier frequency.

10. The method in claim 6, wherein the first carrier frequency and the second carrier frequency are of substantially different values.

11. The method in claim 6, wherein the first carrier frequency is in one frequency band and the second carrier frequency is in a different frequency band.
